(19) United States
(12) Patent Application Publication
(10) Pub. No.: US 2022/0239567 A1
(43) Pub. Date: Jul. 28, 2022

(54) AI-Based Cloud Configurator Using User Utterences

(71) Applicant: Oracle International Corporation, Redwood Shores, CA (US)

(72) Inventor: Johnson MANUEL-DEVADOSS, Redwood Shores, CA (US)

(21) Appl. No.: 17/156,865

(22) Filed: Jan. 25, 2021

(51) Int. Cl. H04L 12/24; G06N 3/08; G06N 3/04; H04L 29/06; G06F 40/40; G06F 40/279; H04L 12/58

(52) U.S. Cl. CPC H04L 41/5045; G06N 3/08; G06N 3/0454; H04L 51/02; H04L 63/0421; G06F 40/40; G06F 40/279; G06N 3/0445

(57) ABSTRACT

Embodiments configure a cloud system that includes a plurality of cloud services. Embodiments receive a user utterance that includes a natural language and extract at least a first entity from the utterance. Embodiments translate the first entity into a cloud intent definition language entity and receive user feedback in response to presenting the cloud intent definition language entity. Embodiments generate an intent based on the cloud intent definition language entity and the feedback and compile the intent into a cloud services policy to be deployed by the cloud system.

### FIELD

One embodiment is directed generally to an artificial intelligence based computer system, and in particular to an artificial intelligence based computer system used to configure cloud computing resources and services.

### BACKGROUND INFORMATION

“Cloud computing” is generally used to describe a computing model which enables on-demand access/availability to a shared pool of computing resources, such as computer networks, servers, software applications, storage and services, and which allows for rapid provisioning and release of resources with minimal management effort or service provider interaction.

Cloud computing provides services generally without direct active management by the user. Cloud computing systems generally describe data centers available to many users over the Internet. Large clouds, predominant today, often have functions distributed over multiple locations from central servers.

However, individual users/clients frequently have a need to have customized policies and procedures that are specific to their requirements. Because the cloud system and infrastructure is typically in control of the cloud provider, it is difficult for clients to customize the cloud to meet their needs without requiring extensive assistance from the cloud provider.

### SUMMARY

Embodiments configure a cloud system that includes a plurality of cloud services. Embodiments receive a user utterance that includes a natural language and extract at least a first entity from the utterance. Embodiments translate the first entity into a cloud intent definition language entity and receive user feedback in response to presenting the cloud intent definition language entity. Embodiments generate an intent based on the cloud intent definition language entity and the feedback and compile the intent into a cloud services policy to be deployed by the cloud system.

### BRIEF DESCRIPTION OF THE DRAWINGS

FIG. 1 is an overview diagram of elements of an AI-based cloud computing configurator system that can implement embodiments of the invention.

FIG. 2 is a block diagram of the AI-based cloud configurator system of FIG. 1 in the form of a computer server/system in accordance with an embodiment of the present invention.

FIG. 3 is a block diagram the illustrates functional elements of the AI-based cloud configurator of FIG. 1 in accordance to embodiments.

FIG. 4 is a block diagram of a neural sequence-to-sequence learning model that implements an intent translator in accordance to embodiments.

FIG. 5 is a flow diagram of the functionality of the AI-based cloud configurator system of FIG. 1 when configuring a cloud system in response to an utterance of a user in accordance with one embodiment.

FIG. 6 is a block diagram of an artificial neural network that implements the intent translator in accordance to embodiments.

### DETAILED DESCRIPTION

One embodiment is an artificial intelligence based system that translates a user's utterance into intents that are used to configure a cloud system. Embodiments include an intent-refinement process that uses machine learning and feedback from the users to translate the user's utterances into cloud configurations. The refinement process uses a sequence-to-sequence learning model to extract intents from natural language and the feedback from the user to improve learning. Embodiments include an intermediate representation that resembles natural language that is suitable to collect feedback from the user but is structured enough to facilitate precise translations. Embodiments interact with a cloud user using natural language and translates the operator input to the intermediate representation before translating to cloud rules/policies.

A “self-driving” cloud is an autonomous cloud configuration that can predict changes and adapt to user behaviors without the intervention of a cloud user. Successfully implementing an autonomous cloud would not only ease cloud management but also reduce operational costs. Recent advances in artificial intelligence (“AI”) offer an opportunity for the adoption of self-driving clouds, as machine learning models can identify patterns and learn how to respond to changes in the cloud.

However, known cloud implementations generally fail to provide the correct tools to cloud users to exploit these new developments in AI, since they generally rely on low-level languages to specify cloud policies and complex interfaces to ensure that the specified policies are deployed correctly. Further, enterprise or personal cloud users generally do not have the skills to program their cloud and can benefit from a user-friendly management system.

In contrast, embodiments provide an infrastructure to allow users to specify high-level policies that dictate how the cloud should behave, such as defining goals related to cloud network quality of service, cloud security, and performance, without needing to know or understand the low-level details that are necessary to program the cloud to achieve these goals. Embodiments extract intent information from pure natural language, and do not require cloud users to learn a new intent definition language and avoid hindering interoperability, deployment, and management of clouds.

Highly complex and, sometimes, conflicting policies in cloud resources may cause cloud intents to derail from the desired behavior of the users. Further, the adoption of programmable cloud technologies introduce a new level of dynamism that results in constant changes in cloud conditions. Therefore, monitoring the cloud after deploying policies and requesting feedback from the user is needed for avoiding misconfigurations.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

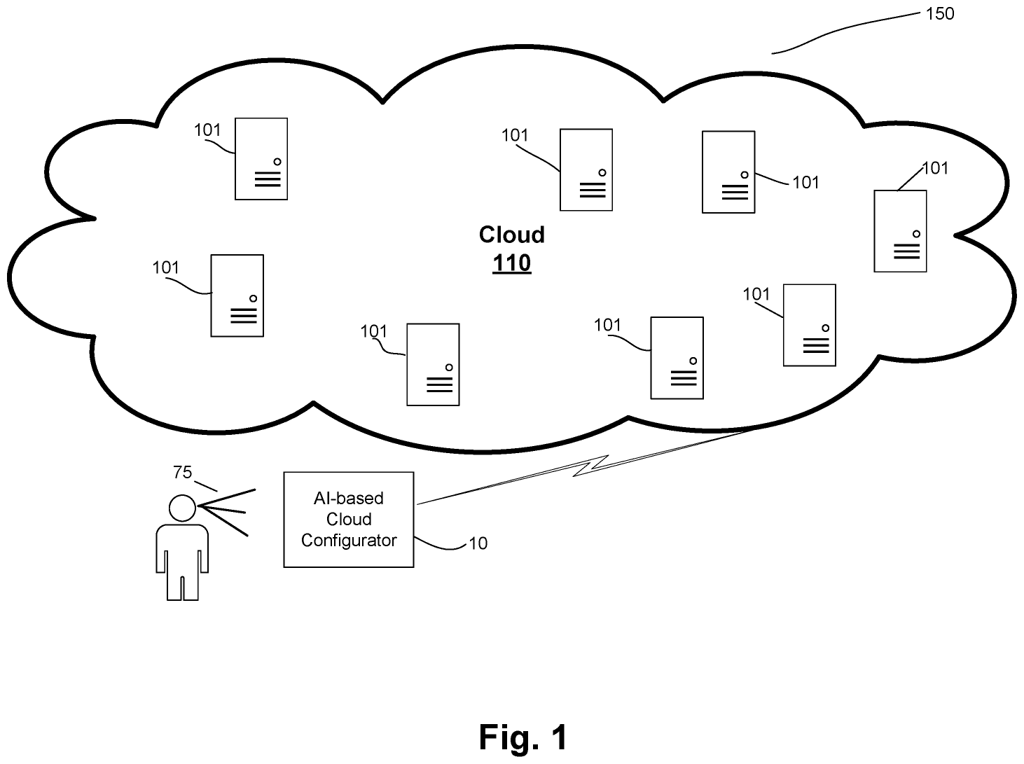

FIG. 1 is an overview diagram of elements of an AI-based cloud computing configurator system 150 that can implement embodiments of the invention. As shown in FIG. 1, system 150 includes a multi-tenant “cloud” computer system 110 that is formed of multiple customer instances or systems 101 (each also referred to as a “pod”). Each cloud instance/pod 101 can be considered a self-contained set of functionality—sometimes just an application server and database, sometimes a complete infrastructure with identity management, load balancing, firewalls and so on. Typically, however, the infrastructure services of cloud 110 are shared across multiple applications and database pods.

Pods 101 that serve smaller customers may be one-to-many, multi-tenant instances. Others are dedicated to one-to-one to a single customer. Some are many-to-one, for example a cluster of pods 101 each serving the separate businesses of a large multi-national corporation. In one embodiment, cloud system 110 is the “Cloud Infrastructure” from Oracle Corp.

System 150 further includes an AI-based cloud configurator system 10 that is externally coupled to cloud 110, or may be internally part of cloud 110. AI-based cloud configurator system 10 receives utterances 75 from a user, and in response configures cloud 110 and all related cloud services such as networks, servers, load balancers, domain name system, databases, etc.

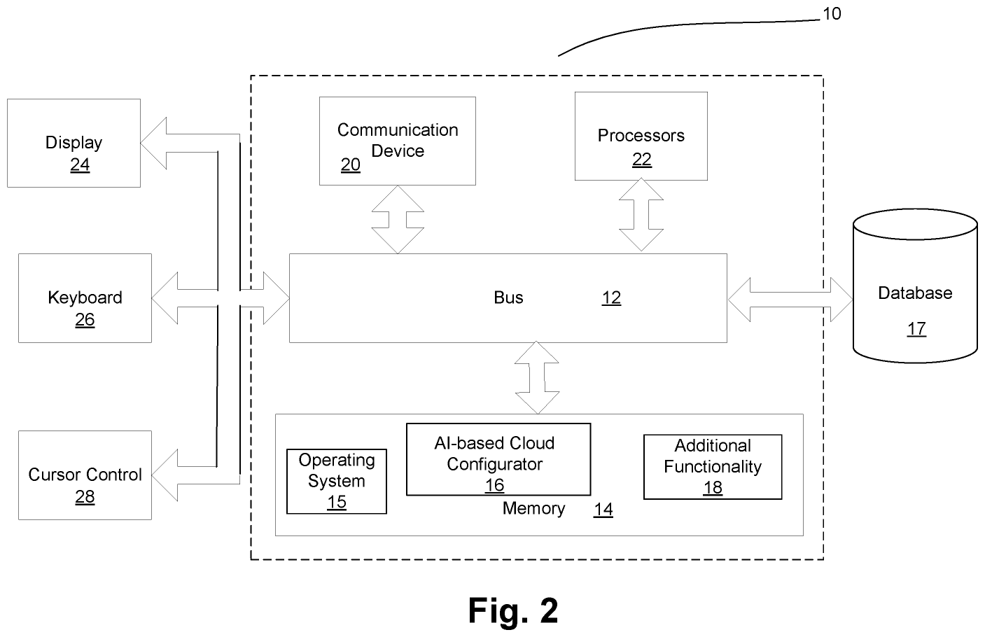

FIG. 2 is a block diagram of AI-based cloud configurator system 10 of FIG. 1 in the form of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”) and includes a microphone for receiving user utterances. A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an AI-based cloud configurator module 16 that uses AI to configure a cloud system in response to an utterance of a user, and all other functionality disclosed herein. System 10 can be part of a larger system. Therefore, system 10 can include one or more additional functional modules 18 to include the additional functionality, such as the “Cloud Service” from Oracle Corp. A file storage device or database 17 is coupled to bus 12 to provide centralized storage for modules 16 and 18, including data regarding any type of issues generated by each of instances/pods 101. In one embodiment, database 17 is a relational database management system (“RDBMS”) that can use Structured Query Language (“SQL”) to manage the stored data.

In one embodiment, particularly when there are a large number of distributed files at a single device, database 17 is implemented as an in-memory database (“IMDB”). An IMDB is a database management system that primarily relies on main memory for computer data storage. It is contrasted with database management systems that employ a disk storage mechanism. Main memory databases are faster than disk-optimized databases because disk access is slower than memory access, the internal optimization algorithms are simpler and execute fewer CPU instructions. Accessing data in memory eliminates seek time when querying the data, which provides faster and more predictable performance than disk.

In one embodiment, database 17, when implemented as an IMDB, is implemented based on a distributed data grid. A distributed data grid is a system in which a collection of computer servers work together in one or more clusters to manage information and related operations, such as computations, within a distributed or clustered environment. A distributed data grid can be used to manage application objects and data that are shared across the servers. A distributed data grid provides low response time, high throughput, predictable scalability, continuous availability, and information reliability. In particular examples, distributed data grids, such as, e.g., the “Oracle Coherence” data grid from Oracle Corp., store information in-memory to achieve higher performance, and employ redundancy in keeping copies of that information synchronized across multiple servers, thus ensuring resiliency of the system and continued availability of the data in the event of failure of a server.

In one embodiment, system 10 is a computing/data processing system including an application or collection of distributed applications for enterprise organizations, and may also implement logistics, manufacturing, and inventory management functionality. The applications and computing system 10 may be configured to operate with or be implemented as a cloud-based system, a software-as-a-service (“SaaS”) architecture, or other type of computing solution.

As disclosed, a “self-driving” cloud in accordance to embodiments has a reduced management complexity due to intelligent and seamless planning. A cloud user can specify cloud policies without worrying how they would be achieved when interacting with embodiments. Further, the cloud user can use natural language to define the cloud behavior. The cloud behavior may include customer expectations to comply with Service Level Agreements (“SLA”s), cloud functions for security, temporal behavior for accommodating large flows during peak hours (e.g., load balancing), or cloud-wide goals such as minimizing cost or reducing traffic costs by relying on cheaper paths in the network.

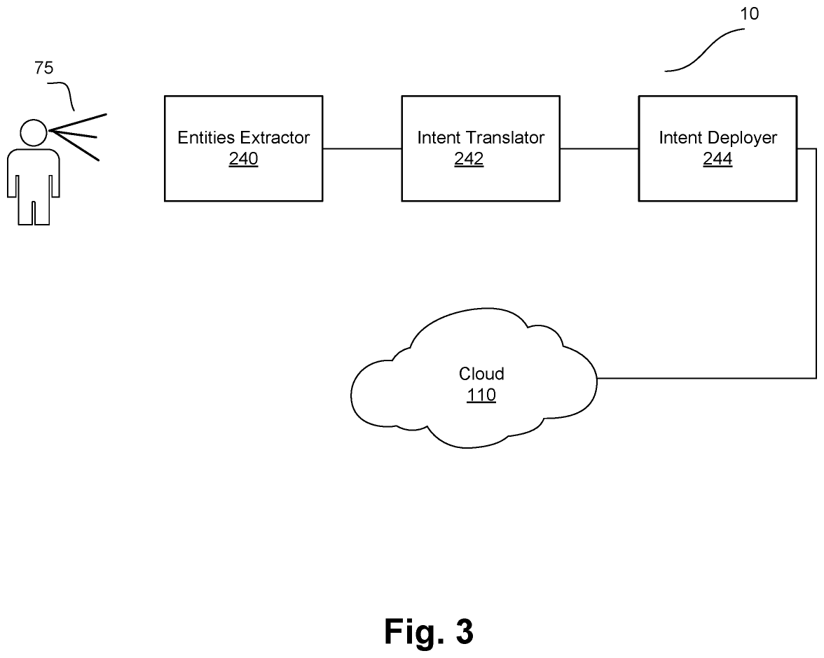

FIG. 3 is a block diagram the illustrates functional elements of AI-based cloud configurator 10 of FIG. 1 in accordance to embodiments. The functionality of FIG. 3 provides a refinement process for intent specification that can learn and adapt itself to achieve the cloud behavior expressed by the user while providing a user-friendly interface for interactions with the user. System 10 includes three stages of the refinement process functionality that interacts with user utterance 75: entities extractor 240 (which includes a chatbot), intent translator 242, and intent deployer 244.

### Entities Extraction

In embodiments, the first step in the intent refinement process at entities extractor 240 is to extract the actions and targets of the cloud behavior expressed in natural language by the user as utterance 75. In embodiments, a chatbot is used to implement human-computer interactions based on natural language conversations. In one embodiment, “Digital Assistant” from Oracle Corp. is used to implement the chatbot and build a conversational AI interface between utterance 75 and AI-based cloud configurator 10.

Entities extractor 240 uses machine learning to generalize example cases, referred to as “entities”, and facilitates the extraction of features in the dialog. Entities extraction is a subtask of information extraction that seeks to locate and classify named entities mentioned in unstructured text into pre-defined categories, such as person names, organizations, locations, medical codes, time expressions, quantities, monetary values, percentages, etc. In the chatbot in embodiments, the entities include security, compliance, cost, monitoring metrics, alerting, site reliability engineering (“SRE”), service level agreement (“SLA”) requirements, temporal restrictions, and endpoints targeted by the user's intent. Digital Assistant provides the ability to deploy the chatbot across multiple platforms, including Amazon's Alexa, or messaging apps, such as Slack and Facebook's Messenger. Therefore, embodiments can allow a personal cloud user to configure their network using voice-activated assistants such as Amazon's Alexa. For example, they could request parental control for their kids' devices.

In embodiments, entities extractor 240 is implemented as an Oracle Digital Assistant chat interface. The chat interface includes a list of entities, which are the key features to be parsed from natural language, and language intents (not related to network intents). Language intents represent possible user interactions that the chatbot creator provides for machine learning training so that Digital Assistant can generalize and learn how to extract the necessary entities from future user interactions.

### Intent Refinement Process

Despite being extremely useful for user interactions, simply using a chatbot does not fulfill all the requirements for cloud resources planning. In embodiments, the entities extracted from natural languages result in key-value pairs representing the user utterances. However, these pairs do not reflect the cloud configuration commands. For instance, if a cloud operator asks a chatbot “Please add additional storage”, a possible extraction result, depending on how the chatbot is built and trained, would be the following entities: “storage”. Therefore, after the chatbot interaction, embodiments still need to translate the entities into a structured intent that can be implemented in a destination cloud resources.

### Intent Translation

With embodiments using Digital Assistant and other implementations, after the chatbot interface extracts all the required entities from the user utterances, the framework calls a representational state transfer (“REST”) application programming interface (“API”) in a backend service designated by a webhook. Webhooks are user-defined Hypertext Transfer Protocol (“HTTP”) callbacks. They are usually triggered by some event, such as pushing code to a repository or a comment being posted to a blog. When that event occurs, the source site makes an HTTP request to the Uniform Resource Locator (“URL”) configured for the webhook. Users can configure them to cause events on one site to invoke behavior on another. In embodiments, the webhook allows the heavy processing for translations to be performed.

Embodiments include a configured webhook from chatbot/entities extractor 240 to intent translator 242 to receive all the extracted entities. These entities are fed to a previously trained sequence-to-sequence learning model, which translates entities to structured intents written in an intent definition language. An intent definition language transforms natural language into device configurations. The intent definition language provides a simple, yet comprehensive, abstraction layer between lower-level policies and the natural language used by operators and home users. While low-level policy enforcers require operators with extensive expertise and management experience to program the intended behavior of a cloud resource/service, natural language is hard to parse and interpret correctly and often inaccurate, creating a huge gap between the intended behavior and the cloud resource/service configurations. Further, translating natural language intent directly to cloud resource/service rules decreases portability and reusability, since each possible destination cloud resource/service has specific features and configuration requirements.

In contrast, the intent definition language in accordance to embodiments of the invention provide an intermediate intent representation that is close to natural language. However, the intent definition language has enough structure that works well as the target for the learning algorithm and allows translation to different target cloud resources. The use of the intent definition language as an intermediate representation in the refinement process decouples the policy extraction from the policy deployment and enforcement. The decoupling, with an intermediate representation that resembles natural language and is easy to understand, allows embodiments to use the feedback from the user/operator before deploying the extracted behavior.

Further, the intent definition language in accordance to embodiments acts as an abstraction layer for other policy mechanisms, reducing the need for operators to learn multiple policy languages for each different type of cloud resource. The design requirements for the intent language grammar in accordance to embodiments include: (i) high legibility, as operators unfamiliar to the language must be able to understand and assert the correctness of the intent; (ii) high expressiveness, to faithfully represent the operator's intention; and (iii) high writability, to allow operators to make adjustments to the generated intents quickly and easily.

An example of the intent definition language is as follows:

```
define intent storage Intent :
  from endpoint ( ‘ FSS’ )
  to endpoint ( ‘ storage ’ )
    client (
  for ‘ VM ’ )
  add middlebox ( ‘ readwrite’ ) , middlebox ( ‘ rate )
  with
    iodepth ( ‘ less ’ , ‘ 5 ’ ),
    rate ( ‘ more or equal ’ , ‘ 98kb ),
    filesize ( ‘ less or equal ’ , ‘ 100MB )
  allow fsync ( ‘ on_close’ )
```

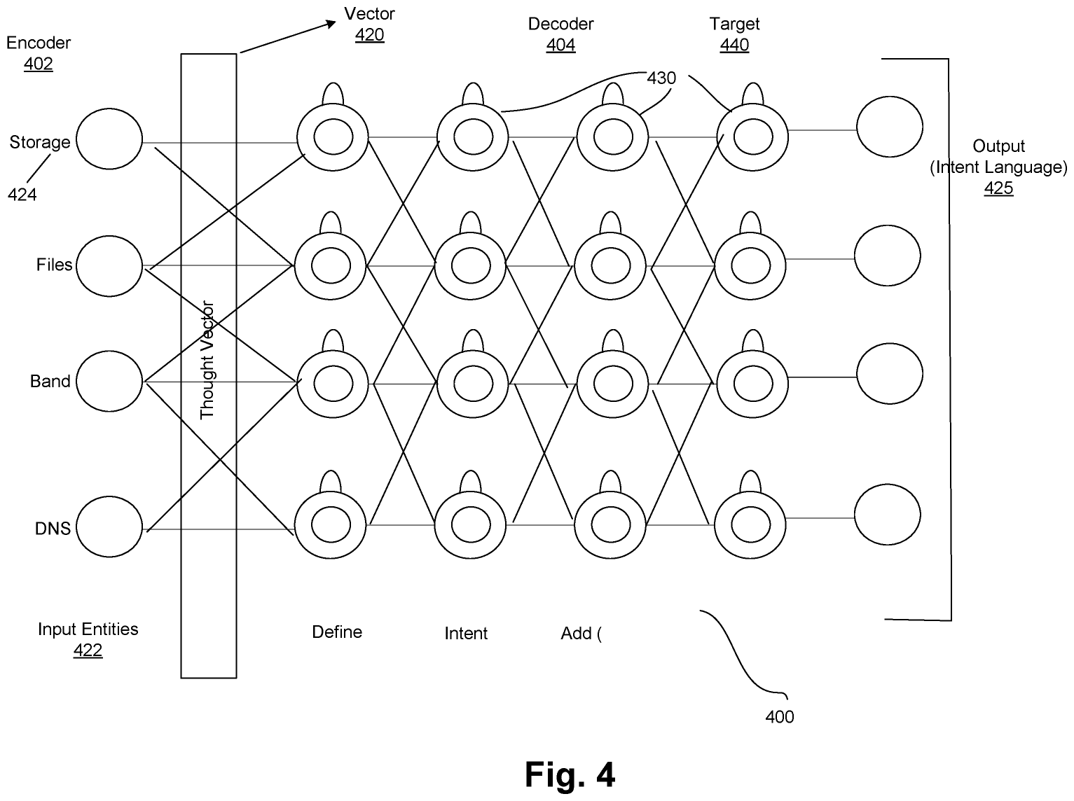

FIG. 4 is a block diagram of a neural sequence-to-sequence learning model 400 that implements intent translator 242 in accordance to embodiments. Model 400 is a Recurrent Neural Network (“RNN”s) with Long Short-Term Memory (“LSTM”) hidden units that form an encoder 402 and a decoder 404. An RNN is a class of artificial neural networks where connections between nodes form a directed graph along a temporal sequence. This allows it to exhibit temporal dynamic behavior. LSTM is an artificial RNN architecture used in the field of deep learning that includes feedback connections. In this model, RNN encoder 402 processes the sequence of words in the form of extracted entities from extractor 240 and generates a thought vector 420, which is a numerical representation of the input sequence. Example entities shown in FIG. 4 include “storage”, “files”, “band” and domain name system (“DNS”). RNN decoder 404 receives thought vector 420 as input and generates a sequence of words in the intent definition language at output 425. In embodiments, decoder 404 includes multiple RNNs 430. Multiple RNNs are used in embodiments to improve the learning rates and prediction accuracy of linguistic models, as it can capture and represent the meaning of each word.

In general, a problem for known neural networks that can used for text-to-text translations is the enormous vocabulary that each language has, which requires large datasets and substantial time to train the models. In contrast, embodiments use previously extracted entities as input and a limited and well-defined language as output. Embodiments pre-process the extracted entities by replacing each extracted entity with a token representing it and using the token representation as input for RNN encoder 402.

This pre-processing includes of replacing each extracted entity with a token representing it and using the token representation as input for RNN encoder 402 (input entities 422). For example, if entities extractor 240 outputs “storage” (at 424), it would use anonymization to convert them to the tokens ‘@middlebox’ and ‘@target’ before starting the intent translation stage. After the translation, a deanonymization is run on the resulting intent program to replace the tokens with the originally extracted entities. By using anonymization, embodiments can reduce the number of training cases needed for the model considerably, since it does not have to consider every possible entity value for network intents. “Define”, “Intent” “Add (rules)” are examples of keywords as shown in the above example of the intent definition language.

Because embodiments do not use words directly as input for the sequence-to-sequence model, each input word of the model is converted to a unique numerical representation. The numerical representation of the anonymized entities are the numeric indices in a pre-built dictionary that contains all words in the model. Therefore, embodiments perform a conversion using a vocabulary with just the words that include the words middlebox and target.

In addition to indexing the words of the input sequences, embodiments perform Word Embedding vectorization in the first layer of RNN encoder 402 to concisely represent the indexed words as arrays of real values as thought vector 420. The word vectorization improves the learning rates and prediction accuracy of linguistic models, as it can capture and represent the meaning of each word. The array of real values, which represents the sequence of anonymized entities given as input to the sequence-to-sequence model, is then processed one by one by RNN encoder 410 to generate thought vector 420. RNN decoder 404 then uses encoded thought vector 420 to predict a sequence of statements in the output language.

The structured intent definition generated by decoder 404 is then presented to cloud user 75 for confirmation on the extracted desired behavior through the chatbot interface. User 75 may either confirm the correctness of the intent program or make adjustments if necessary. After the user's response, the intent program and the input entities are included in the training database of the sequence-to-sequence model, and a new training round is initiated. In this interaction, the user's feedback during the translation is explicitly considered, thus ensuring that the results improve every time user 75 requests an action.

Intent translator 242 in one embodiment is implemented as a Python Restful API service that is called by the Digital Assistant chat interface right after it extracts the entities. The service can interact with the chatbot interface to ask for additional information if necessary. Besides this interaction, the API provides a sequence-to-sequence model developed using Keras that is used to train this model. The weights of this model are trained and computed with an automatically generated dataset of input entries containing examples of anonymized entities and the corresponding natural language program, which is also anonymized. After generating the Navi intent and confirming it with the user feedback, the model is retrained by adding the intent to the training dataset.

Intent deployer 244 in one embodiment is implemented as a separate Python Restful API service that is called by intent translator 242 when it finishes the translation process.

### Intent Deployment

After having a structured intent program verified by user 75, intent deployer 244 can compile and deploy it into destination cloud resources in cloud system 110. In this stage, embodiments make assertions to verify any conflicts between the extracted intent and the cloud resource/service configuration and warn the user through the chatbot interface (e.g., an intent asking for more storage than is available on the required path). Embodiments then translate the intent programs into configuration commands.

Embodiments can optionally include an intent behavior monitor module that ensures that the deployed policies respect the intents extracted by the refinement process. The intent behavior monitor module uses a neural network to predict which parameters should be monitored, and then monitors the parameters and notifies the operator in case of disparities between the behavior and the intent.

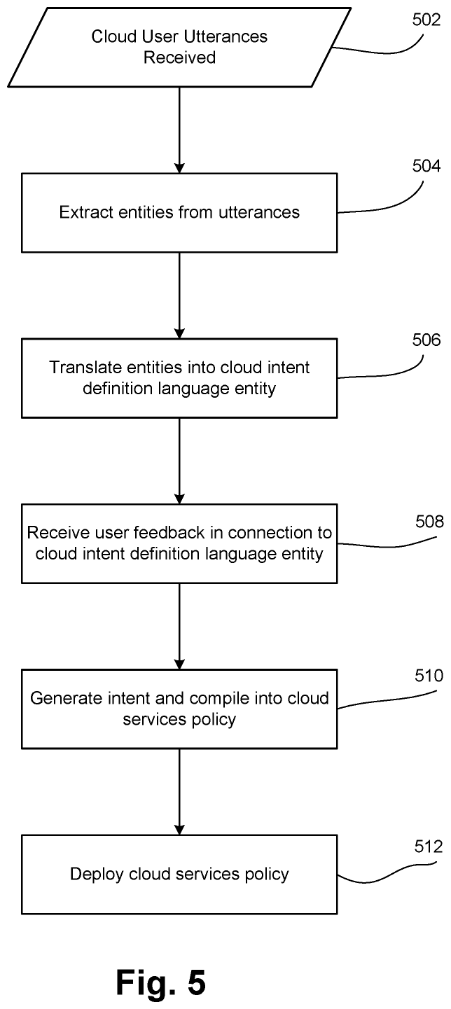

FIG. 5 is a flow diagram of the functionality of AI-based cloud configurator system 10 of FIG. 1 when configuring any services of cloud system 101 in response to an utterance of a user in accordance with one embodiment. In one embodiment, the functionality of the flow diagram of FIG. 5 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 502, the user utterances 75 for configuring cloud system 110 and related services are received. For example, an input utterance may be “Add storage from FSS to backend for client VM, with Rate less than 5 and 95 kb of file size, and allow FSS only”.

At 504, entities are extracted from the utterances. An intelligent chatbot interface is used to extract the main actions and targets (i.e., entities of a user intent from natural language). One embodiment implements the chatbot interface using the Oracle Digital Assistant, which uses machine learning to identify key aspects in the user's utterances without the need for extensively covering every possible entity value. In this chatbot, examples of entities are the cloud computing, analytics, cost management, compute, containers, database, Internet of Things (“IoT”), identity, storage, content delivery, security compliances, network endpoints, monitoring, logging, and temporal configurations for the policy. A natural language interface enables the deployment of this solution in distinct scenarios. For example, a personal cloud user can use embodiments to prioritize streaming traffic in their network during specific hours of the day. Another example is as follows: “Add security policy on VM and intrusion detection from security center to backend for client Load Balancer security group, with deny 0.0.0.0/0 and deny port 22”.

At 506, the entities are translated into high level language based entities. Embodiments use a neural sequence-to-sequence learning model to translate the extracted entities into a high-level structured cloud definition program. The program closely resembles natural language and is an intent definition language as disclosed above.

At 508, the high-level language is presented to the cloud users for confirmation on the extracted behavior. For personal cloud users with no technical knowledge, the confirmation can come from a voice assistant or a graphical interface.

At 510, the intent is generated and compiled into a cloud services policy. The cloud services policy is according to the destination cloud resources such as computing, network, security, analytics, logging and monitoring, etc. Embodiments also make assertions to verify any conflicts between the extracted intent and the cloud configuration. For example, an intent asking for more virtual machine (“VM”) storage than is available on the required storage generates an assertion to warns the user through the chatbot interface.

At 512, the cloud services are deployed and changes are made to the cloud system based on the user specified cloud service policies.

One embodiment can be implemented as a software module for performing a neural network based cloud resources configuration using cloud intent definition language in an electronic data processing system. The software module includes a model setup block operable to receive client verbal input including information specifying a cloud resource configuration details, extract at least one entity from the utterance, and generate parameters for the cloud resource setup based on the received information. The software module further includes a modeling algorithm block operable to select and initialize a neural network modeling algorithm based on the generated cloud resource setup and a model building block operable to receive training data and build a neural network model using the training data and the selected neural network modeling algorithm.

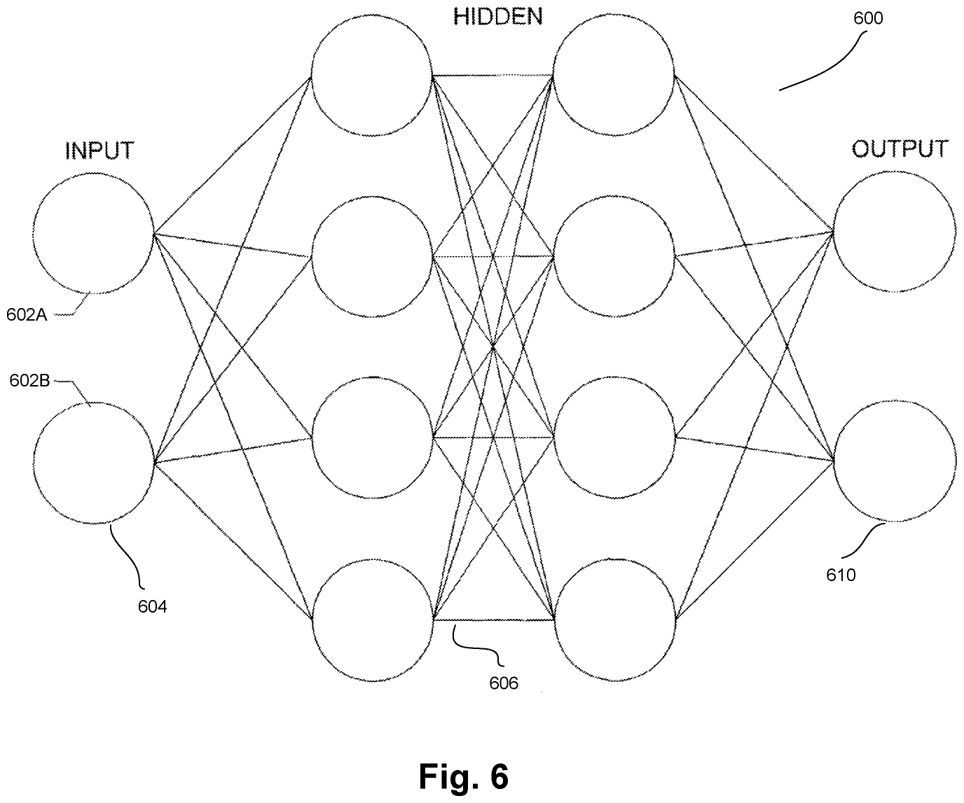

FIG. 6 is a block diagram of an artificial neural network 600 that implements intent translator 242 in accordance to embodiments. Artificial neural network 600 can be used instead of neural network 400 of FIG. 4 in certain embodiments and is an example of an artificial neural network of a type that may be used as neural network 400 of FIG. 4. Neural networks, such as network 600, are typically organized in layers. Layers are made up of a number of interconnected nodes, such as nodes 602A and 602B, each of which contains an activation function. Patterns are presented to the network via the input layer 604, which communicates to one or more hidden layers 606 where the actual processing is done via a system of weighted connections 608. The hidden layers then link to an output layer 610 where the answer is output.

Most artificial neural networks contain some form of learning rule, which modifies the weights of the connections according to the input patterns that are presented. In a sense, artificial neural networks learn by example as do their biological counterparts.

There are many different kinds of learning rules used by neural networks. A typical well-known learning rule is the delta rule. The delta rule is often utilized by the most common class of artificial neural networks, which are called backpropagational neural networks (“BPNN”s). Backpropagation refers to the backwards propagation of error in the neural network.

In embodiments, neural network 600 is implemented as a plurality of recurrent neural networks that work together to transform one sequence to another. An encoder network condenses an input sequence into a vector, and a decoder network unfolds that vector into a new sequence.

As disclosed, embodiments utilize an intent-refinement process for intelligent extraction of intents from natural language that uses feedbacks from cloud users to improve learning. Embodiments facilitate the compilation of intents into cloud services policies and deployment of intents in heterogeneous cloud resources. Embodiments implement a high-level, comprehensive intent definition language that resembles the English language and acts as an abstraction layer for other policy mechanisms, reducing the need for users to learn a new policy language for each different type of network.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A method of configuring a cloud system comprising a plurality of cloud services, the method comprising:
receiving a user utterance comprising a natural language;
extracting at least a first entity from the utterance;
translating the first entity into a cloud intent definition language entity;
receive user feedback in response to presenting the cloud intent definition language entity;
generating an intent based on the cloud intent definition language entity and the feedback; and
compiling the intent into a cloud services policy to be deployed by the cloud system.

2. The method of claim 1, wherein the extracting the first entity from the utterance comprises using a chatbot.

3. The method of claim 1, wherein the translating the first entity into the cloud intent definition language entity comprises using a trained neural network.

4. The method of claim 3, wherein the trained neural network comprises a neural sequence-to-sequence learning model comprising a plurality of Recurrent Neural Network with Long Short-Term Memory hidden units.

5. The method of claim 1, wherein the cloud intent definition language entity comprises an intent definition language that provides an abstraction layer between the cloud services policy and the natural language.

6. The method of claim 3, further comprising replacing the first entity with a token using anonymization.

7. The method of claim 1, wherein the cloud services policy comprises at least one of policies related to: computing, network, security, analytics, or logging and monitoring.

8. A cloud configurator system comprising:
an entities extractor adapted to receive a user utterance comprising a natural language and extract at least a first entity from the utterance;
an intent translator adapted to translate the first entity into a cloud intent definition language entity; and
an intent deployer adapted to receive user feedback in response to presenting the cloud intent definition language entity, generate an intent based on the cloud intent definition language entity and the feedback and compile the intent into a cloud services policy to be deployed by a cloud system.

9. The system of claim 8, the entities extractor comprising using a chatbot.

10. The system of claim 8, the intent translator comprising a trained neural network.

11. The system of claim 10, wherein the trained neural network comprises a neural sequence-to-sequence learning model comprising a plurality of Recurrent Neural Network with Long Short-Term Memory hidden units.

12. The system of claim 8, wherein the cloud intent definition language entity comprises an intent definition language that provides an abstraction layer between the cloud services policy and the natural language.

13. The system of claim 10, the intent translator further adapted to replace the first entity with a token using anonymization.

14. The system of claim 8, wherein the cloud services policy comprises at least one of policies related to: computing, network, security, analytics, or logging and monitoring.

15. A computer-readable medium having instructions stored thereon that, when executed by one or more processors, cause the processors to configure a cloud system comprising a plurality of cloud services, the configuring comprising:
receiving a user utterance comprising a natural language;
extracting at least a first entity from the utterance;
translating the first entity into a cloud intent definition language entity;
receive user feedback in response to presenting the cloud intent definition language entity;
generating an intent based on the cloud intent definition language entity and the feedback; and
compiling the intent into a cloud services policy to be deployed by the cloud system.

16. The computer-readable medium of claim 15, wherein the extracting the first entity from the utterance comprises using a chatbot.

17. The computer-readable medium of claim 15, wherein the translating the first entity into the cloud intent definition language entity comprises using a trained neural network.

18. The computer-readable medium of claim 17, wherein the trained neural network comprises a neural sequence-to-sequence learning model comprising a plurality of Recurrent Neural Network with Long Short-Term Memory hidden units.

19. The computer-readable medium of claim 15, wherein the cloud intent definition language entity comprises an intent definition language that provides an abstraction layer between the cloud services policy and the natural language.

20. The computer-readable medium of claim 15, wherein the cloud services policy comprises at least one of policies related to: computing, network, security, analytics, or logging and monitoring.
